(19) United States
(12) Patent Application Publication
(10) Pub. No.: US 2026/0284933 A1
(43) Pub. Date: Sep. 24, 2026

(54) SAW BLADE ASSEMBLY FOR A FLOOR MILLING TOOL

(71) Applicant: HUSQVARNA AB, Huskvarna (SE)

(72) Inventors: Hugo VAN RIJN, Huskvarna (SE); Barry VAN EIJDEN, Huskvarna (SE); David KWANT, Huskvarna (SE); John BAARDEWIJK, Huskvarna (SE)

(21) Appl. No.: 19/474,335

(22) PCT Filed: Mar. 21, 2024
(86) PCT No.: PCT/SE2024/050255

§ 371 Date: Oct. 10, 2025

(30) Foreign Application Priority Data
Apr. 12, 2023 (SE) 2350422-8

(51) Int. Cl. B28D 1/18; B28D 1/04; E04G 23/02

(52) U.S. Cl. CPC B28D 1/186; B28D 1/045; B28D 1/048; E04G 23/0285

(57) ABSTRACT

A saw blade assembly (300) for a floor shaver (100), the assembly comprising a saw blade carrier (310) and a plurality of saw blades (330), the saw blade carrier (310) comprising a hollow elongated portion (320) extending along a central axis (A) from a first end (321) of the carrier to a second end (322) of the carrier, where the hollow elongated portion (320) is arranged to receive a drive shaft (230) along the central axis (A) in an internal volume extending from its first end (321), where the hollow elongated portion (320) is arranged to receive and to support a plurality of saw blades (330) arranged perpendicular to the central axis (A) on an exterior surface of the elongated portion (320), where the saw blade carrier (310) is operable to transfer a drive torque from the drive shaft (230) to the plurality of saw blades (330), where at least one of the saw blades (330) comprises a plurality of abrasive segments (610) arranged along an outer periphery of the saw blade (331), where two adjacent abrasive segments (331) are separated by a gap (620), where the outer periphery of the saw blade adheres to a first rotational symmetry (R1), the saw blade (331) comprising a central non-circular aperture (630) with a second rotational symmetry (R2), where the order of the first rotational symmetry (R1) differs from all integer multiples of the order of the second rotational symmetry (R2).

### TECHNICAL FIELD

The present disclosure relates to construction equipment for processing hard surfaces such as concrete, asphalt and stone floors. There are disclosed floor shaver machines, saw blades, saw blade assemblies and methods for efficient and cost-effective processing of concrete surfaces and the like.

### BACKGROUND

It is sometimes desired to remove a portion of a hard surface, such as a concrete floor surface, e.g., in preparation for refurbishing the surface by adding a new coating material, or in preparation for producing a more flat surface.

A floor shaver is a machine comprising an assembly of abrasive blades placed inside a housing. The blade assembly is often referred to as a saw drum, and the housing as a drum housing. Once the machine is switched on, the drum rotates at high speed to grind off a portion of the surface being processed. Dust and contaminants created by the shaver can be extracted by a dedicated dust extractor. This makes the process almost dust free, which is an advantage. A floor shaver is capable of removing almost any type of floor surface material.

Floor shavers are generally known, but there is a desire to provide floor shavers that are more easy to use, in particular when it comes to inspection and maintenance.

EP 0 617 170 A2 describes a surface processing machine where the abrasive blades are supported by a hollow elongated member, which hollow elongated member also receives the drive shaft of the machine and transfers drive torque from the shaft to the abrasive blades.

EP 0 735 192 A2, U.S. Pat. No. 5,477,845, and US 2010/0116116 A1 describe various machinery where abrasive elements are threaded directly onto a non-circular drive shaft to allow a transfer of drive torque from the drive shaft to the abrasive elements.

U.S. Pat. No. 7,278,597 B2 describes a saw blade carrier where a plurality of saw blades are assembled into a drum-like structure having a non-circular center aperture configured to receive a matching drive shaft.

US 2023/010738 A1 and U.S. Pat. No. 2,437,958 describe surface processing machinery comprising drum structures.

### SUMMARY

It is an objective of the present disclosure to provide improved surface processing equipment such as floor shavers and floor scarifiers, as well as related components, assemblies, and operating methods. This objective is at least in part obtained by a saw blade assembly for a floor shaver. The saw blade assembly comprises a plurality of saw blades arranged on a saw blade carrier. The saw blade carrier comprises a hollow elongated portion extending along a central axis from a first end of the carrier to a second end of the carrier. The hollow elongated portion is arranged to receive a drive shaft of the floor shaver along the central axis in an internal volume extending from its first end. The hollow elongated portion is also arranged to receive and to support a plurality of saw blades arranged perpendicular to the central axis on an exterior surface of the elongated portion. The saw blade carrier is operable to transfer a drive torque from the drive shaft to the plurality of saw blades. This saw blade carrier allows for easier installation and removal of the blade assembly from the drive shaft, and for reduced overall vibration of the floor shaver during use, compared to prior art designs. Aspects of the saw blade carrier also allows it to be used as an adapter that allows installation of saw blades on different types of surface processing equipment, such as floor scarifiers.

An exterior surface of the hollow elongated portion optionally has a non-circular outer cross-section shape perpendicular to the central axis that is arranged to rotationally fix a saw blade having a central non-circular aperture matched to the non-circular outer cross-section shape of the exterior surface of the hollow elongated portion. The saw blades can be installed on the hollow elongated portion away from the floor shaver machine, and mounted as a complete assembly, which could be advantageous in some cases. The saw blades can also be installed onto the hollow elongated portion when it is attached to the floor shaver, allowing flexibility in use.

According to some aspects, the hollow elongated portion comprises grooves and/or ridges that extend along the central axis on the exterior surface. The grooves are arranged to receive matching lugs formed in central apertures of the saw blades, while the ridges can be matched to cut-out portions in the central apertures of the saw blades. The grooves and/or ridges can be formed straight and parallel to the central axis, or helically formed around the exterior surface of the hollow elongated portion. The grooves and/or ridges allow the saw blades to be conveniently installed onto the saw blade carrier. The advantage of a helical form over a straight form is that the helical grooves and/or ridges will cause the saw blade to strive laterally in use, along the central axis of the saw blade carrier, thereby compressing the saw blade assembly during use to reduce rattle and vibration.

The saw blade carrier preferably comprises a first flange arranged at the first end of the hollow elongated member, and a second flange arranged at the second end of the hollow elongated member. At least one of the first and second flanges is arranged to transfer drive torque from the drive shaft to the hollow elongated portion. The tolerances between the central apertures of the flanges and the drive shaft can be made relatively small without complicating installation of the saw blade assembly onto the drive shaft, which is an advantage. In this case the internal volume of the hollow elongated member does not have to engage the drive shaft. The first flange and/or the second flange are advantageously also arranged slidable relative to the hollow elongated portion along the central axis. This way a pressure applied to the flange, e.g., from bolts or the like, will compress the plurality of saw blades in the axial direction, thus reducing rattle and vibration, which is an advantage.

The first flange and/or the second flange are/is optionally rotationally fixed to the hollow elongated portion in one or more ways. The first flange and/or the second flange may for instance comprise non-central and radially offset apertures matched to respective protrusions formed in the hollow elongated portion in connection to the first and and/or the second end. The protrusions can slide axially in the apertures, but provide a rotational lock of the flange relative to the hollow elongated member to efficiently transfer torque there inbetween.

At least one of the flanges preferably has a central aperture with a non-circular cross-section shape perpendicular to the central axis that can be matched to the cross section shape of the drive shaft. This non-circular cross-section shape of the flange central aperture rotationally fixes the flange to the drive shaft and therefore contributes to the torque transfer between drive shaft and flange. Hence, torque can be transferred between the drive shaft and saw blade assembly in several ways, which is an advantage.

In addition, as a complement or as an alternative to the torque transfer function of the flanges, at least a portion of the internal volume of the hollow elongated portion can be delimited by a non-circular inner cross-section shape perpendicular to the central axis. This non-circular inner cross-section shape can be matched to the cross-section shape of the drive shaft in order to rotationally fix the hollow elongated portion to the drive shaft and thus transfer torque there inbetween in an efficient manner.

One or both flanges, and/or the at least one portion of the inner volume of the hollow elongated portion of the saw blade carrier can be configured with a rotationally symmetric inner cross-section shape perpendicular to the axis, i.e., the cross section shape of the flanges and/or of the interior of the hollow elongated portion seen along the central axis may be formed in a rotationally symmetric manner. This allows the saw blade carrier to be installed on the drive shaft without rotating it very much, even though it is non-circular for torque transferring purposes. The inner cross-section shape of the elongated member and/or the flanges may for instance be formed as an equilateral polygon shape, such as a hexagonal shape.

According to some aspects, the degree of rotational symmetry of the inner cross-section shape is at least three, and preferably six.

According to some aspects, the saw blade carrier comprises one or more grease nipples configured to convey a lubricant to the internal volume of the hollow elongated portion. This lubricant simplifies installation and removal of the saw blade carrier, and may also absorb some of the vibration transmitted from the saw blades to the rest of the machine.

The objective is also at least in part obtained by a saw blade assembly comprising a saw blade carrier, and a plurality of saw blades. This saw blade assembly preferably also comprises a plurality of spacers interleaved with the saw blades, where one or more of the spacers can be a resilient spacer arranged to generate force in the direction of the central axis.

Parts of the disclosure also relates to a saw blade for a floor shaver, suitable for use on its own or together with the saw blade carrier and the saw blade assembly discussed above. The saw blade comprises a plurality of abrasive segments arranged along an outer periphery of the saw blade, where two adjacent abrasive segments are separated by a gap, and where the outer periphery of the saw blade adheres to a first rotational symmetry. The saw blade also comprises a central non-circular aperture with a second rotational symmetry, where the order of the first rotational symmetry differs from all integer multiples of the order of the second rotational symmetry. This has the effect of offsetting the gaps between the saw blades from each other if the saw blade is rotated on the drive shaft. The distribution of gaps gives a better end result when using the floor shaver, and also promotes cooling of the saw blades.

The order of the first rotational symmetry may, e.g., be an even integer number and the order of the second rotational symmetry can then be an odd integer number, such as 6 and 17, which is a configuration that has been shown to give good results.

According to some aspects, the central non-circular aperture is a circular aperture with lugs extending radially inwards and arranged symmetrically around the aperture, but other aperture shapes can of course be used with similar effect.

Floor shavers and methods are also disclosed herein, associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example floor shaver;

FIG. 2 illustrates a saw blade assembly according to prior art;

FIGS. 3-4 illustrate an example saw blade assembly;

FIG. 5 shows a saw blade assembly being mounted onto a drive shaft;

FIGS. 6A-B illustrate an advantageous difference in rotational symmetry;

FIGS. 7A-B show saw blade gap configurations on a saw blade carrier;

FIG. 8 illustrates a saw blade holding function of a carrier end flange;

FIGS. 9A-B show an example use of a resilient spacer;

FIG. 10 is a flow chart illustrating methods;

FIG. 11 illustrates cross section shapes with rotational symmetry;

FIG. 12 shows example components of a saw blade carrier;

FIGS. 13A-B show examples of saw blade carrier external surfaces; and

FIGS. 14A-B show an example saw blade assembly mounting arrangement.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

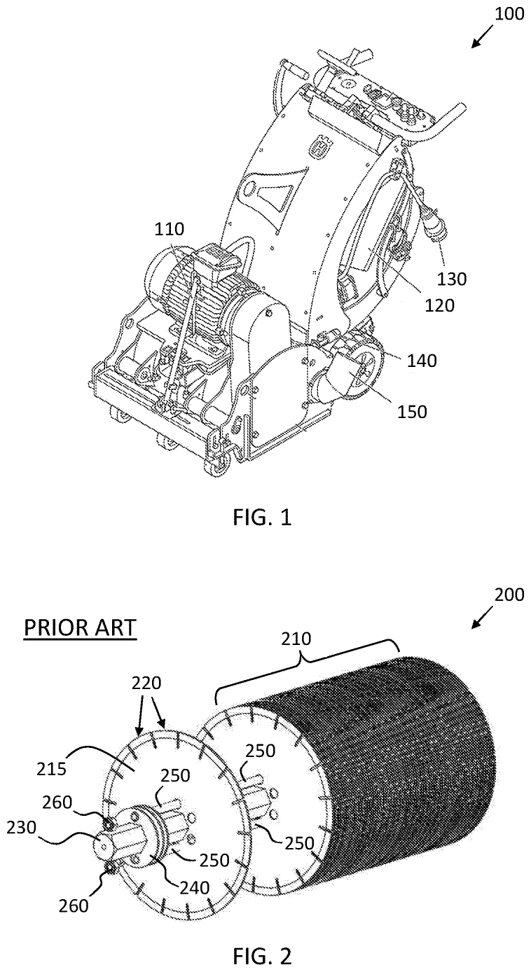

FIG. 1 illustrates an example floor shaver 100. The floor shaver 100 is powered by an electric motor 110 supported by a chassis 120 of the machine 100. An electrical mains connection 130 is provided in order to power the electric machine 110. However, other power sources can also be used, such as combustion engines of various kinds. This disclosure is not limited to any particular type of floor shaver, rather, the teachings herein can be used with many different types of floor shavers 100. The floor shaver 100 also comprises an interface for connecting a supply of water 140, and also a connection for a dedicated dust extractor 150. Both the supply of water and the connection to the dust extractor ensure that the generation of dust during operation is kept at a tolerable level.

The floor shaver 100 comprises a saw blade assembly, often referred to as a saw drum, which is essentially a collection of saw blades arranged on a drive shaft where they are interleaved (distanced from each other) by spacers. An example saw blade assembly 200 according to prior art is illustrated in FIG. 2. This saw blade assembly 200 comprises a plurality of saw blades 210. Each saw blade comprises abrasive elements 220 arranged along its periphery in a known manner. Diamond abrasives are commonly used with this type of saw blade, but other abrasives can also be used, such as carbide abrasives. The saw blades in the prior art assembly 200 are arranged directly on a drive shaft 230 of the floor shaver. Each saw blade 215 has a hexagonal central aperture which allows it to be threaded onto the drive shaft with spacers inbetween, and then held in place by pressing members 240 connected together by rods 250 that extend through the saw blades in direction of the drive shaft as illustrated in FIG. 2. The saw blade assembly 200 is held together by nuts 260 engaging threaded portions on the ends of the rods 250.

The play between the saw blade central apertures and drive shaft cannot be kept very low in the design of FIG. 2, since then the saw blades become too difficult to install on the drive shaft. Hence, some vibration and rattle is experienced when using the floor shaver, which is undesired. It may also be difficult in some cases to remove the saw blades from the drive shaft 230 since they may get stuck in use.

For easier installation and removal of the blade assembly from the drive shaft, and for reduced overall vibration of the floor shaver during use, it has been realized that it is better to assemble the saw blades and the spacers on an adapter or saw blade carrier, which then in turn mates with and attaches to the drive shaft of the floor shaver for transfer of torque between the drive shaft and the saw blades. The use of an adapter between drive shaft and saw blades in this manner allows for a reduction in tolerance between drive shaft and carrier which reduces overall vibration of the floor shaver. The adapter is also more easy to install and to remove from the drive shaft compared to when each saw blade is installed separately on the drive shaft. The places where the adapter mates with the drive shaft for transfer of torque between drive shaft and saw blades can furthermore be lubricated in a more convenient manner to facilitate installation and removal of the blade assembly, compared to when saw blades are installed separately directly onto the drive shaft 230.

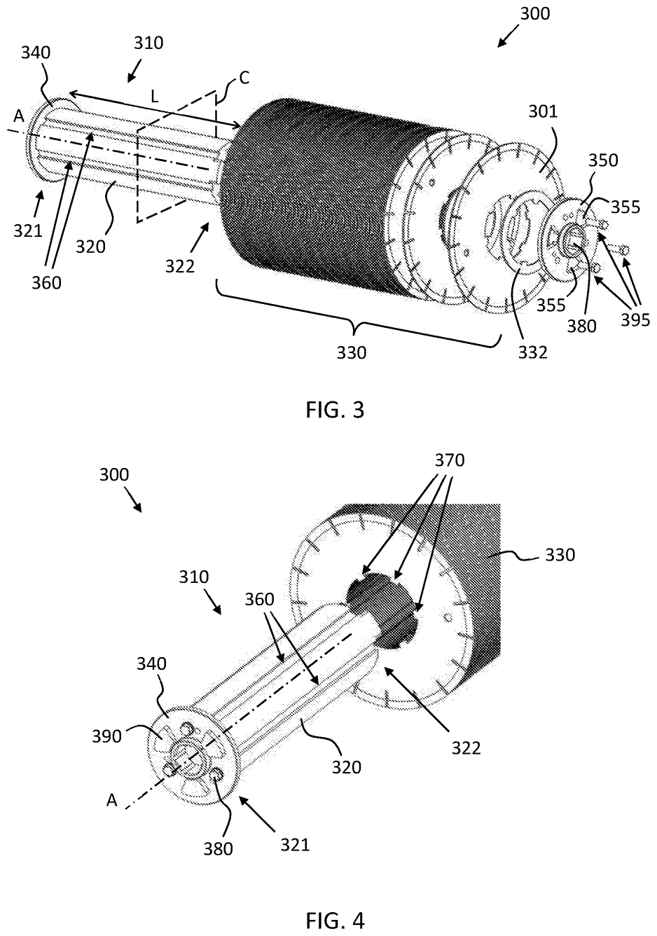

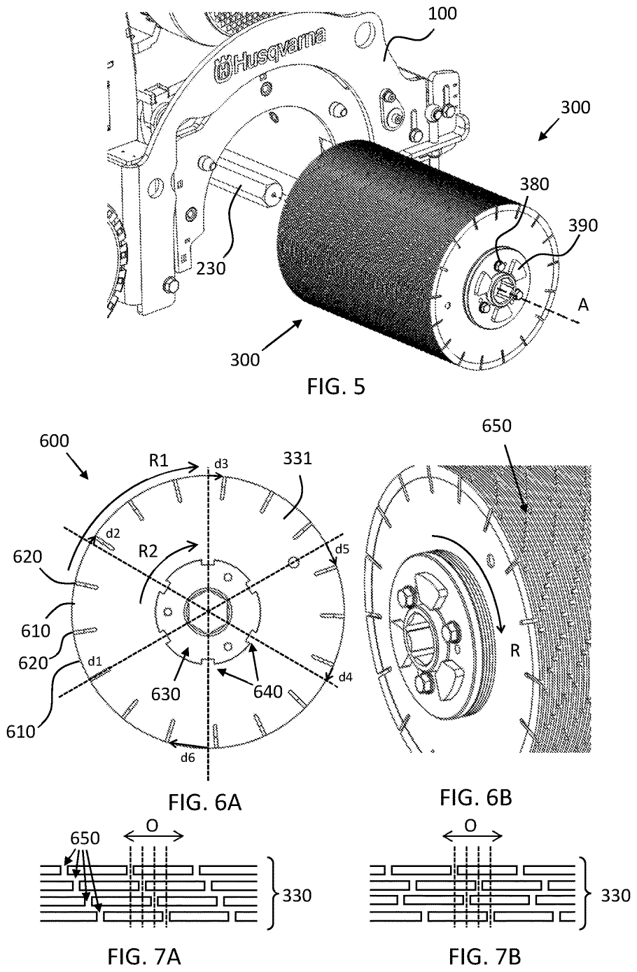

The saw drum adapter proposed herein is basically a hollow sleeve-like member into which the drive shaft 230 is inserted. The adapter then supports the saw blades and the spacers, as illustrated in FIG. 3 and in FIG. 4. This makes it possible to fill the complete saw drum with saw blades outside of the floor shaver machine and then attach it as one piece to the machine without misalignment issues involving the blades and the drive shaft, despite small tolerances between drive shaft and saw blade carrier, as illustrated in FIG. 5.

With reference to FIG. 3, the hollow elongated portion 320, the saw blades 330, and the other components of the saw blade assembly 300 has cross-sectional shapes perpendicular to the central axis A, i.e., seen along the direction of the central axis A. This cross-sectional shape is the shape seen when looking at an object along the central axis A, illustrated by the dashed surface C in FIG. 3.

It has been found that sawblades with 17 diamond-based abrasive segments can be used with an adapter that has 6 slots for positioning the blades. This ensures that the gaps separating the abrasive segments will be separated on the saw blade assembly, so that the gaps between segments are not all on the same line aligned with the drive shaft. This gives a better end result on the processed surface and the blades also transport heat better during operation. This feature of deliberately designing the saw blade assembly to exhibit a difference in rotational symmetry between abrasive segment geometry and saw blade central aperture geometry will be discussed in more general terms below in connection to FIGS. 6A-B and FIGS. 7A-B.

FIGS. 3, 4 and 5 show a saw blade assembly 300 comprising an example of the proposed saw blade carrier 310 and a plurality of saw blades 330. The carrier 310 comprises a hollow elongated portion 320 extending along a central axis A from the first end 321 of the carrier to a second end 322 of the carrier. The hollow elongated portion 320 is arranged to receive the drive shaft 230 along the central axis A in an internal volume that extends from its first end 231. The internal volume preferably extends through the entire hollow elongated portion 320, but it may also extend along a smaller part of the hollow elongated portion 320, i.e., from the first end 321 to a place somewhere inbetween the first and second ends. The hollow elongated portion 320 is a sleeve-like member into which the drive shaft 230 of the floor shaver 100 can be inserted and then held in position axially by some type of fastening arrangement, such as bolts at the first and/or second ends. The portions of the saw blade carrier which is in torque transferring contact with the drive shaft 230 can be machined with high precision to fit snugly about the drive shaft, which reduces the amount of rattle and vibration between drive shaft and saw blade carrier. The inside of the saw blade carrier 310 and/or the outside of the drive shaft 230 can also be lubricated in order to reduce friction between drive shaft 230 and the interior of the saw blade carrier 310. According to some aspects, one or more grease nipples are arranged in the saw blade carrier 310 in order to allow lubrication of the contact zone between drive shaft and the inside of the saw blade carrier 310, e.g., by conveying lubricant to the internal volume of the hollow elongated portion 320. Such lubrication also acts as a vibration absorber that reduces rattle between the drive shaft 230 and the saw blade carrier 310, which is an advantage.

FIG. 5 illustrates an example of a blade assembly being mounted onto a hexagonal cross-section drive shaft 230 of a floor shaver 100. As will be discussed in more detail below, the saw blade carrier interior surface that contacts the drive shaft to transfer torque between drive shaft and the saw blades exhibits a degree of rotational symmetry, which means that the saw blade assembly does not have to be rotated very much in order to fit onto the drive shaft, which is an advantage. Rotational symmetry will be discussed in more detail below in connection to FIGS. 6A-B and FIGS. 7A-B.

The hollow elongated portion 320 is arranged to receive and to support a plurality of saw blades 330 arranged perpendicular to the central axis A on an exterior surface of the elongated portion 320 where they are rotationally fixed. The saw blade carrier 310 is operable to transfer a drive torque from the drive shaft 230 to the plurality of saw blades 330. This torque transfer can be achieved in different ways, e.g., by using flanges at one or both ends of the hollow elongated portion 320 with non-circular central apertures matched to the shape of the drive axle, as illustrated in FIG. 4, and/or by forming at least parts of the internal volume of the hollow elongated portion 320 with a non-circular cross section shape matched to the shape of the drive axle 230, such that a rotation motion of the drive shaft is transferred to the hollow elongated portion 320 which in turn rotates the plurality of saw blades.

The example saw blade carrier 310 in FIGS. 3-5 comprises flanges 340, 350 which are rotationally fixed to the hollow elongated portion 320 in two ways. Bolts 395 secure each flange to the hollow elongated portion 320, and allows for axial pressure to be applied to the flange, which then compresses the plurality of saw blades 330 in the axial direction A. There are also protrusions 390 formed at the ends of the hollow elongated portion 320 which enter matching non-central radially offset apertures355 formed radially offset from the center in each flange. These protrusions provide an additional rotational lock of the flange relative to the hollow elongated portion 320, such that torque can be transferred from the flange to the hollow elongated portion 320 in an efficient and reliable manner. According to one example, the flanges have non-circular central apertures 380 with shapes matched to the cross section shape of the drive shaft 230, such that torque from the drive shaft is transferred via the flanges 340, 350 to the hollow elongated portion 320, which then in turn drives the plurality of saw blades rotationally fixed thereon.

In the example saw blade carrier 310 illustrated in FIGS. 3-5, the torque from the hexagonal cross-section drive shaft 230 is transferred to the two flanges 340, 350 via the central apertures of the flanges that have hexagonal cross section shapes matched to that of the drive shaft. The flanges 340, 350 in turn are both bolted to the hollow elongated portion 320 as well as rotationally fixed to the hollow elongated portion 320 by the cooperating protrusions 390 and radially offset apertures 355. Thus, the torque from the drive shaft is transferred to the hollow elongated portion 320. The hollow elongated portion has an exterior surface with a non-circular outer cross-section shape perpendicular to the axis A that is matched to the central apertures of the saw blades, to rotationally fix the saw blades that have matching central non-circular apertures 630.

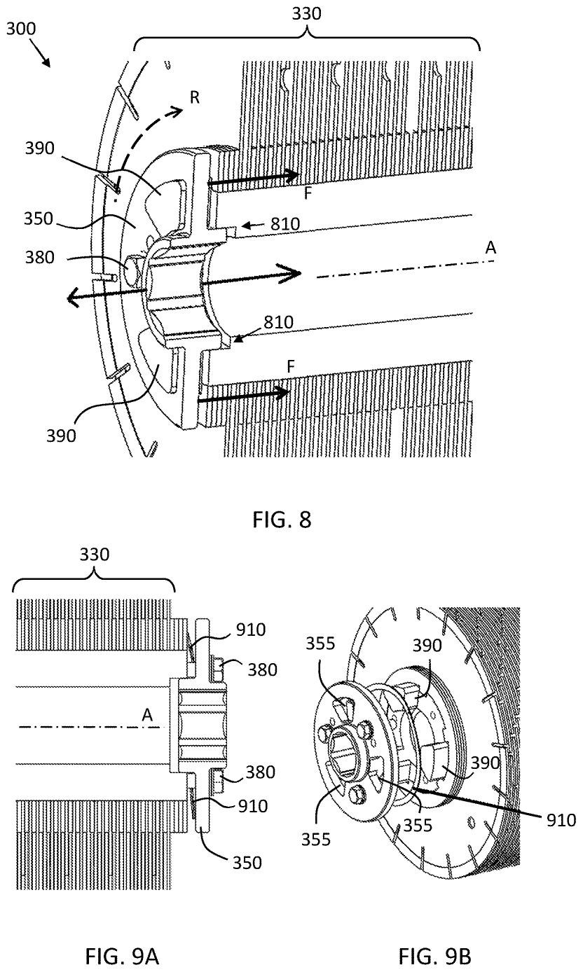

Regarding the flanges 340, 350, with reference also to FIG. 8, it is generally appreciated that the saw blade carrier 310 may comprise a first flange 340 arranged at the first end 321 and a second flange 350 arranged at the second end 322, where at least one of the first and second flanges 340, 350 is arranged to transfer drive torque from the drive shaft 230 to the hollow elongated portion 320. The first flange 340 and/or the second flange 350 are preferably arranged slidable 810 relative to the hollow elongated portion 320 along the central axis A. This feature of the flanges allows them to be used to compress the plurality of saw blades and spacers in the axis direction, and will be discussed in more detail below in connection to FIG. 8.

It is also generally appreciated that the first flange 340 and/or the second flange 350 optionally comprise non-central radially offset apertures 355 that are radially offset from a center of the flange and matched to respective protrusions 390 formed in the hollow elongated portion 320 in connection to the first and and/or the second end 321, 322. These protrusions allow the flange to slide axially relative to the hollow elongated portion 320, while at the same time rotationally locking the flange with respect to the hollow elongated portion. At least one of the flanges 340, 350 preferably also has a central aperture 380 with a non-circular cross-section shape perpendicular to the central axis A, which allows torque to be transferred from the drive shaft via the flange to the hollow elongated portion 320. In addition to the cooperating protrusions 390 and radially offset apertures 355, bolts 395 can be used to improve the rotational lock between flange and hollow elongated portion 320. The internal volume of the hollow elongated portion 320 may also be formed with a non-circular inner cross-section shape perpendicular to the axis A, in addition to the non-circular central apertures of the flanges or as an alternative means for transferring torque between drive shaft and the plurality of saw blades. The entire internal volume of the hollow elongated portion may be formed in a non-circular manner, or just one or more portions thereof. A hexagonal inner cross-section shape matched to the shape of the drive shaft 230 can, for instance, be used in order to efficiently transfer torque between drive shaft 230 and the saw blades 330.

The saw blades are received on the hollow elongated portion 320 such that the extension planes of the saw blades are parallel and orthogonal to the central axis A. The saw blades 330 are preferably separated by spacers 332 that separate the saw blades from each other. The hollow elongated portion 320 exterior surface has a non-circular outer cross-section shape perpendicular to the axis A, which means that the saw blades can be rotationally fixed on the saw blade carrier if the central apertures on the saw blades are matched to the outer shape of the hollow elongated portion 320.

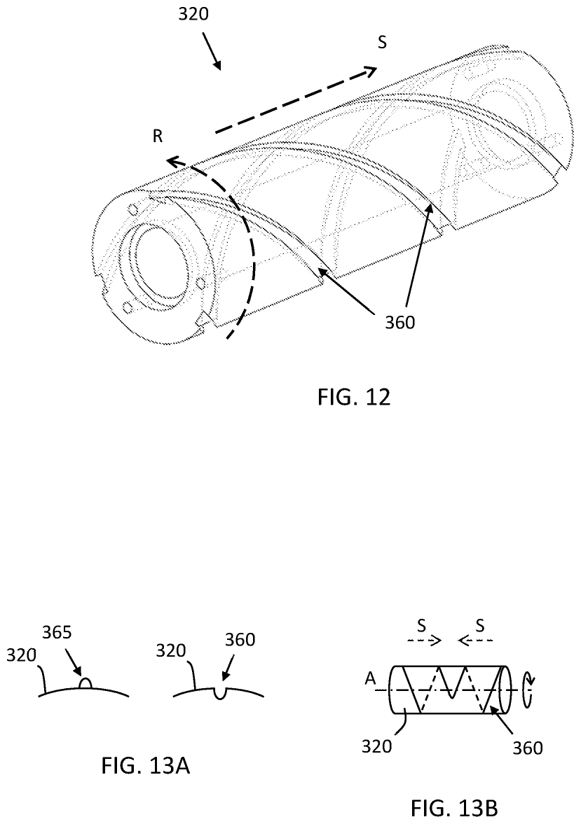

According to an example, the hollow elongated portion 320 comprises grooves 360 and/or ridges (365) extending along the central axis A on the exterior surface. The grooves 360 are arranged to receive matching lugs 370 formed in central apertures of the saw blades 330 while the ridges mate with cut-out portions in the saw blade central aperture, to transfer torque from the elongated portion 320 to the saw blades in use. The grooves 360 in the Figures are straight grooves. However, helical grooves formed in the exterior surface of the hollow elongated portion 320 may also be used with advantage. Such helical grooves also push the saw blades in use towards one end of the hollow elongated portion 320, where they are pressed together. An example of such helical grooves is illustrated in FIG. 12 and in FIGS. 13A-B. As the saw drum is rotated in use, the helical pattern of grooves will cause the saw blade to strive S towards one end of the drum due to the resistance from the surface. The plurality of saw blades 330 will therefore be tightly packed together in use, which reduces rattle and vibration.

Ridges formed on the exterior surface of the hollow elongated portion 320 can also be used in combination or as alternative to the grooves, to secure the saw blades. Either straight ridges or helically formed ridges can be used.

FIG. 12 illustrates an example saw drum with helical grooves 360 formed in the same direction of rotation along the entire saw drum. This type of helically formed groove pattern (or ridge pattern) will compress the saw blades in direction S towards one end of the drum. FIG. 13A illustrates an example ridge 365 and an example groove 360. Both forms are applicable separately or in combination.

FIG. 13B illustrates an example helical pattern formed along two different directions of rotation. The groove and/or ridge pattern has a helical form that changes direction of rotation at the center of the saw drum. This has the effect of compressing the same blades in use towards the center of the saw drum or towards the ends of the saw drum, depending on the direction of rotation of the saw drum in use and on the direction of the helical form of the grooves and/or ridges.

Any non-circular outer cross-section shape can be used to transfer torque from the drive shaft to the saw blades, such as a wavy pattern that repeats after an angle interval, any equilateral polygon shape, or a pattern of protrusions that repeat after an angle interval to give rotational symmetry of some order. It is generally preferred that an exterior surface of the hollow elongated portion 320 has a non-circular outer cross-section shape perpendicular to the axis A arranged to rotationally fix a saw blade 331 having a central non-circular aperture 630 matched to the non-circular outer cross-section shape.

Some example cross sectional shapes that can be used for the central apertures in the flanges and/or in the internal surface of the hollow elongated portion 320 and/or for the exterior surface of the hollow elongated portion 320 are illustrated in FIG. 11, where the order of rotational symmetry for each shape has also been indicated.

According to some aspects the saw blade carrier 310 has a rotationally symmetric inner cross-section shape perpendicular to the axis A which makes contact with the drive shaft 230 in use. The rotationally symmetric inner cross-section shape of the saw blade carrier 310 may be formed by the central apertures 380 in the flanges and/or by the shape of the internal volume of the hollow elongated portion 320. This rotational symmetry ensures that the saw blade assembly does not need to be rotated very much about the center axis A when it is fitted onto the drive shaft (which of course has a cross section shape that matches that of at least a part of the saw blade carrier 310). The degree of rotational symmetry is at least three, and preferably six. The hexagonal cross-section shape, for instance, has rotational symmetry order 6.

Rotational symmetry, also known as radial symmetry in geometry, is the property a shape has when it looks the same after some rotation by a partial turn. An object's degree of rotational symmetry is the number of distinct orientations in which it looks exactly the same for each rotation. Rotational symmetry of order n, also called n-fold rotational symmetry, or discrete rotational symmetry of the nth order, with respect to a particular point (in 2D) or axis (in 3D) means that rotation by an angle of 360°/n (180°, 120°, 90°, 72°, 60°, etc.) does not change the object. A “1-fold” symmetry is no symmetry since all objects look alike after a rotation of 360°. The hexagon cross-section shape in the Figures has a rotational symmetry of order 6. A triangle cross-section would have had a rotational symmetry of order 3, while a square cross-section has a rotational symmetry of order 4. FIG. 11 illustrates some other cross section shapes that all exhibit rotational symmetry.

With reference to FIGS. 6A-B and FIG. 7A-B, the saw blades 331 preferably comprise a plurality of abrasive segments 610 arranged along an outer periphery of the saw blade 331. Any two adjacent abrasive segments 331 are separated by a gap 620. The outer periphery of the saw blade adheres to a first rotational symmetry R1. This means that the saw blade can be rotated in steps of a given angle 360°/n, such that the saw blade will look the same after each rotation.

The saw blade 331 also comprises a central non-circular aperture 630 with a second rotational symmetry R2, and the order of the first rotational symmetry R1 differs from all integer multiples of the order of the second rotational symmetry R2. This means that the gaps 650 between abrasive elements 610 will be offset O against each other if the saw blade 331 is rotated on the carrier, as illustrated in FIG. 6B. The gaps can be offset along a diagonal as shown in FIG. 7A by choosing proper saw blade rotations on the carrier, or more randomly as illustrated in FIG. 7B. An advantage of arranging the gaps between abrasive elements of the saw blade assembly in this manner is that the floor shaving result becomes more even, and the heat transport ability of the blade assembly also improves.

To get an intuition of the above, consider FIG. 6A where the distances d1, d2, d3, d4, d5, d6 from a line intersecting the lugs 640 to the closest gap in clockwise direction has been indicated. Due to the difference in symmetry order, these distances are all different, which means that if a saw blade is rotated one angular step of 360°/6 on the drive shaft, the locations of the gaps assume radial positions that are unique to that angular position of the saw blade on the drive shaft.

It is noted that this difference in rotational symmetry between central saw blade aperture and periphery of the saw blade is not necessary if the exterior surface of the hollow elongated portion is formed with helical ridges or grooves, as exemplified in FIG. 12 and in FIGS. 13A-B, since this rotation along the central axis will offset the saw blade abrasive segments in the desired manner.

The order of the first rotational symmetry R1 may be configured as an even integer and the order of the second rotational symmetry R2 may then be configured as an odd integer.

According to some aspects, the order of the first rotational symmetry is 6, i.e., each saw blade can be fitted onto the carrier at six different rotation angles.

According to some aspects, the order of the second rotational symmetry is 17, i.e., each saw blade can be rotated seventeen times in discrete steps without changing the alignment of the abrasive segments.

Generally, it is preferred that the first order of symmetry is different from all integer multiples of the second order of symmetry, since this allows the gaps to be separated on the saw blade assembly in a desired manner.

According to some aspects, the central non-circular aperture 630 is a disc with lugs 640 extending radially inwards and arranged symmetrically around the aperture 630.

As mentioned above, the saw blade assembly 300 normally comprises a plurality of spacers 332 interleaved with the saw blades 330, to distance the saw blades from each other. One or more of the spacers 332 are advantageously formed as a resilient or flexible spacer arranged to generate force in direction of the central axis A when compressed, such as a disc spring or the like. Using such resilient spacers between saw blades or between saw blades and flange has been shown to reduce vibration generated by the floor shaver 100, which is an advantage. FIGS. 9A and 9B show an example of the use of disc springs 910 to reduce vibration by the saw blade assembly.

Generally, the saw blade carriers 310 discussed herein has an extension length L along the central axis A of at least 40 mm and preferably at least 330 mm. Different numbers of saw blades can be arranged on the saw blade carrier 310 for different operation widths, i.e., widths of the trench that is cut by the floor shaver. The table below provides some examples for a given saw blade carrier geometry.

| Operation width, mm | No. of diamond blades | No. of 2.5 mm spacers |
|---|---|---|
| 340 | 80 | 85 |
| 300 | 71 | 92 |
| 250 | 59 | 100 |
| 200 | 47 | 108 |
| 150 | 35 | 116 |
| 100 | 24 | 125 |
| 50 | 12 | 133 |

According to the example in the table above, the hollow elongated portion 320 is arranged to receive and to support up to 80 saw blades 301 interleaved by up to 85 spacers 332, for a maximum operation width of 340 mm. Both larger and smaller saw blade carriers are of course conceivable. It is also possible to design saw blade drums capable of carrying more than 80 blades, such as 85 blades or more, separated by a suitable number of spacers.

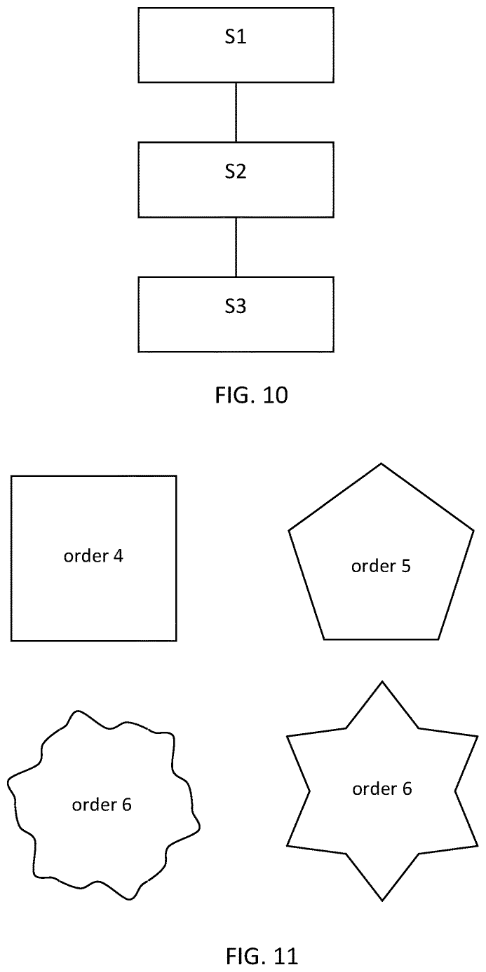

FIG. 10 shows a flow chart illustrating a method for processing a surface by a floor shaver 100, the method comprises providing S1 a saw blade carrier 310 having a hollow elongated portion 320 extending along a central axis A from a first end 321 of the carrier to a second end 322 of the carrier, assembling S2 a plurality of saw blades 330 on the saw blade carrier 310, interleaved by a number of spacers 332, and locking S3 the saw blades in place by flanges 340, 350 on the first and second ends 321, 322 of the saw blade carrier. The method also comprises mounting S3 the saw blade assembly 300 onto a drive shaft 230 of the floor shaver 100, and processing S4 the surface by the floor shaver 100.

Many of the technical features of the saw blade carriers discussed herein can advantageously be used on their own without the other features. This is particularly true for the helically formed ridges and/or grooves arranged on the exterior of the hollow elongated portion, as exemplified in FIG. 12 and in FIGS. 13A-B. The helically formed ridges, grooves, or the combination of ridges and grooves mate with matching lugs or cut-out portions formed in the central apertures of the saw blades to rotationally fix the saw blades onto the saw blade carrier, such that torque can be transferred from the saw blade carrier to the saw blades. The helically formed ridges 365 and/or grooves 360 cause the saw blades to strive in direction of the central axis A in use, which compresses the plurality of saw blades and therefore reduces vibration. The helically formed ridges and/or grooves can be formed in a single direction of rotation as illustrated in FIG. 12 or in two different directions of rotation as illustrated in FIG. 13B. In the case of two directions of rotations the saw blades can be made to strive towards the center of the saw blade drum or towards the first and second ends of the saw blade drum.

There is disclosed herein a saw blade carrier 310 for a floor shaver 100. The saw blade carrier 310 is arranged to receive and to support a plurality of saw blades 330 arranged perpendicular to a central axis A of the saw blade carrier 310 on an exterior surface of the saw blade carrier 310. The exterior surface of the saw blade carrier 310 comprises grooves 360 and/or ridges 365 extending along the central axis A, where the grooves 360 and/or ridges 365 are arranged to receive respective matching lugs 370 and/or respective cut-out portions formed in central apertures of the saw blades 330. The grooves 360 and/or ridges 365 are helically formed around the exterior surface of the hollow elongated portion 320, which causes the saw blades to strive S along the central axis A in use, thereby compressing the saw blades in the axial direction.

A saw blade carrier having an internal volume cross section shape seen along the central axis A that is non-circular, e.g., that has an hexagonal cross shape, effectively provides a rotational lock between the saw blade carrier and a drive shaft matched to the non-circular inner shape of the saw blade carrier. Some floor scarifiers have this type of non-circular drive shaft. Hexagonal drive shafts are for instance common on floor scarifiers. Hence, an adapter as discussed herein can be used to allow saw blade drums to be used with floor scarifier machines. It is an advantage that the same machine can be used for more than one purpose, i.e., to carry more than one type of surface processing tool. There is also disclosed herein saw blade carrier 310 for a floor scarifier. The saw blade carrier comprises a hollow elongated portion 320 extending along a central axis A from a first end 321 of the carrier to a second end 322 of the carrier, where the hollow elongated portion 320 is arranged to receive a drive shaft 230 along the central axis A in an internal volume extending from its first end 321, where at least a portion of the internal volume of the hollow elongated portion 320 has a non-circular cross-section shape perpendicular to the central axis A, arranged to rotationally fix the saw blade carrier 310 to the drive shaft 230. The hollow elongated portion 320 is arranged to receive and to support a plurality of saw blades 330 arranged perpendicular to the central axis A on an exterior surface of the elongated portion 320. The saw blade carrier 310 is operable to transfer a drive torque from the drive shaft 230 to the plurality of saw blades 330.

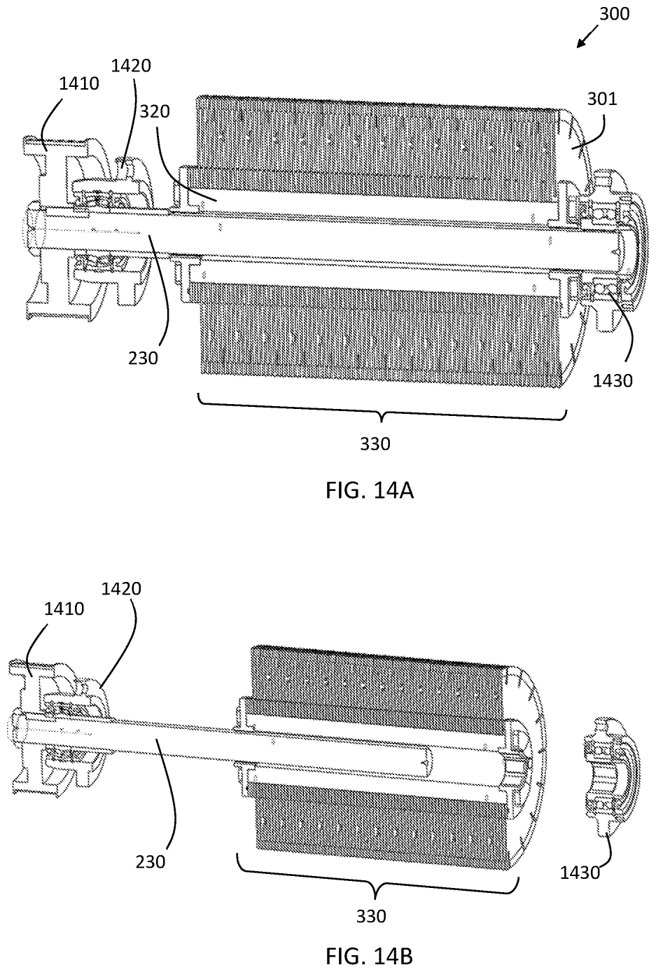

FIGS. 14A-B illustrate how the saw blade assembly 300 discussed above can be supported on a floor shaver such as the floor shaver 100 in FIG. 1. The saw blade assembly 300 is assembled on the drive shaft 230 of the shaver 100. The drive shaft 230 is rotatably supported on opposite ends of the drive shaft by support elements 1420, 1430. A drive wheel 1410 is fixed to the drive shaft 230 in order to transmit torque from a drive motor to the drive shaft 230.

1. A saw blade assembly for a floor shaver, the assembly comprising a saw blade carrier and a plurality of saw blades,
the saw blade carrier comprising a hollow elongated portion extending along a central axis from a first end of the carrier to a second end of the carrier, wherein the hollow elongated portion is arranged to receive a drive shaft along the central axis in an internal volume extending from its first end, wherein the hollow elongated portion is arranged to receive and to support a plurality of saw blades arranged perpendicular to the central axis on an exterior surface of the elongated portion, wherein the saw blade carrier is operable to transfer a drive torque from the drive shaft to the plurality of saw blades,
wherein at least one of the saw blades comprises a plurality of abrasive segments arranged along an outer periphery of the saw blade, wherein two adjacent abrasive segments are separated by a gap, wherein the outer periphery of the saw blade adheres to a first rotational symmetry, the saw blade comprising a central non-circular aperture with a second rotational symmetry, wherein the order of the first rotational symmetry differs from all integer multiples of the order of the second rotational symmetry.

2. A saw blade carrier for a floor shaver, the carrier comprising
a hollow elongated portion extending along a central axis from a first end of the carrier to a second end of the carrier,
wherein the hollow elongated portion is arranged to receive a drive shaft along the central axis in an internal volume extending from its first end,
wherein the hollow elongated portion is arranged to receive and to support a plurality of saw blades arranged perpendicular to the central axis on an exterior surface of the elongated portion, wherein an exterior surface of the hollow elongated portion has a non-circular outer cross-section shape perpendicular to the axis arranged to rotationally fix a saw blade having a central non-circular aperture-matched to the non-circular outer cross-section shape of the exterior surface of the hollow elongated portion, and
wherein the saw blade carrier is operable to transfer a drive torque from the drive shaft to the plurality of saw blades.

3. The saw blade carrier according to claim 2, wherein the hollow elongated portion comprises grooves and/or ridges extending along the central axis on the exterior surface, wherein the grooves and/or ridges are arranged to receive matching lugs and/or cut-out portions formed in central apertures of the saw blades.

4. The saw blade carrier according to claim 3, wherein the grooves and/or ridges are straight and parallel to the central axis.

5. (canceled)

6. The saw blade carrier according to claim 2, wherein at least a portion of the internal volume of the hollow elongated portion has a non-circular cross-section shape perpendicular to the axis, arranged to rotationally fix the saw blade carrier to the drive shaft.

7. The saw blade carrier according to claim 6, wherein the non-circular inner cross-section shape is a non-circular rotationally symmetric inner cross-section shape.

8. (canceled)

9. (canceled)

10. The saw blade carrier according to claim 2, comprising a first flange arranged at the first end, and a second flange arranged at the second end, wherein at least one of the first and second flanges is arranged to transfer drive torque from the drive shaft to the hollow elongated portion.

11. The saw blade carrier-according to claim 10, wherein the first flange and/or the second flange are/is arranged slidable relative to the hollow elongated portion along the central axis and wherein the first flange and/or the second flange are/is rotationally fixed to the hollow elongated portion.

12. (canceled)

13. (canceled)

14. The saw blade carrier according to claim 10, wherein at least one of the flanges has a central aperture with a non-circular cross-section shape perpendicular to the axis arranged to rotationally fix the at least one flange to the drive shaft.

15-17. (canceled)

18. The saw blade carrier according to claim 2, comprising one or more grease nipples configured to convey a lubricant to the internal volume of the hollow elongated portion.

19. The saw blade carrier according to claim 2, wherein an extension length of the hollow elongated portion along the central axis is at least 40 mm.

20. The saw blade carrier according to claim 2, wherein the hollow elongated portion is arranged to receive and to support at least 80 saw blades interleaved by spacers, such as 85 saw blades.

21. A saw blade assembly comprising a saw blade carrier according to claim 2, and a plurality of saw blades.

22. The saw blade assembly according to claim 21, comprising a plurality of spacers interleaved with the saw blades.

23. The saw blade assembly according to claim 21, wherein one or more of the spacers is a resilient spacer arranged to generate force in direction of the central axis.

24. The saw blade assembly according to claim 21,
wherein at least one saw blade comprises a plurality of abrasive segments arranged along an outer periphery of the saw blade, wherein two adjacent abrasive segments are separated by a gap, wherein the outer periphery of the saw blade adheres to a first rotational symmetry,
the saw blade comprising a central non-circular aperture with a second rotational symmetry, wherein the central non-circular aperture matches the exterior surface of the hollow elongated portion of the saw blade carrier,
wherein the order of the first rotational symmetry differs from all integer multiples of the order of the second rotational symmetry.

25. The saw blade assembly according to claim 24, wherein the order of the first rotational symmetry is an even integer number and the order of the second rotational symmetry is an odd integer number.

26-28. (canceled)

29. A saw blade for a floor shaver, the saw blade comprising a plurality of abrasive segments arranged along an outer periphery of the saw blade, wherein two adjacent abrasive segments are separated by a gap, wherein the outer periphery of the saw blade adheres to a first rotational symmetry,
the saw blade comprising a central non-circular aperture with a second rotational symmetry,
wherein the order of the first rotational symmetry differs from all integer multiples of the order of the second rotational symmetry.

30. The saw blade according to claim 29, wherein the order of the first rotational symmetry is an even integer number and the order of the second rotational symmetry is an odd integer number.

31. (canceled)

32. (canceled)

33. The saw blade according to claim 29, wherein the central non-circular aperture is a circular aperture with lugs extending radially inwards and arranged symmetrically around the aperture.

34. A method for processing a surface by a floor shaver, the method comprising:
providing a saw blade carrier-having a hollow elongated portion extending along a central axis from a first end of the carrier to a second end of the carrier, wherein an exterior surface of the hollow elongated portion has a non-circular outer cross-section shape perpendicular to the axis arranged to rotationally fix a saw blade having a central non-circular aperture matched to the non-circular outer cross-section shape of the exterior surface of the hollow elongated portion,
assembling a plurality of saw blades on the saw blade carrier, interleaved by a number of spacers, and
locking the saw blades in place by flanges on the first and second ends of the saw blade carrier,
mounting the saw blade assembly onto a drive shaft of the floor shaver, and
processing the surface by the floor shaver.

35. (canceled)

36. A saw blade carrier for a floor scarifier, the carrier comprising
a hollow elongated portion extending along a central axis from a first end of the carrier to a second end of the carrier,
wherein the hollow elongated portion is arranged to receive a drive shaft along the central axis in an internal volume extending from its first end,
wherein at least a portion of the internal volume of the hollow elongated portion has a non-circular cross-section shape perpendicular to the central axis, arranged to rotationally fix the saw blade carrier to the drive shaft,
wherein the hollow elongated portion is arranged to receive and to support a plurality of saw blades arranged perpendicular to the central axis on an exterior surface of the elongated portion, and
wherein the saw blade carrier is operable to transfer a drive torque from the drive shaft to the plurality of saw blades.
